(19) United States
(12) Patent Application Publication
(10) Pub. No.: US 2025/0055266 A1
(43) Pub. Date: Feb. 13, 2025

(54) WIRE STRIPPER WITH CUTTING SUPPORT STRUCTURE

(71) Applicant: KAUW YEHI INDUSTRIAL CO., LTD., New Taipei City (TW)

(72) Inventor: Yu-Ting YEN, New Taipei City (TW)

(21) Appl. No.: 18/232,807

(22) Filed: Aug. 10, 2023

(51) Int. Cl. H02G 1/12

(52) U.S. Cl. CPC H02G 1/1241; H02G 1/1212

(57) ABSTRACT

A wire stripper has a first handle, a second handle, a blade set, a spring, and a pair of support blocker plates. The second handle is pivoted to the first handle by a pivot. The blade set has a first blade and a second blade, which are connected to the first handle and the second handle respectively. The blade set is fixed with the first handle or the second handle by a screw. Two ends of the spring are respectively fixed on the first handle and the second handle. An end of each of the support blocker plates is connected to the first handle, and another end thereof is extended to the second handle. The disclosure can provide support to a cutting process and the blade set can be replaced when being worn down.

### BACKGROUND

### Technical Field

The disclosure relates to a hand tool, particularly to a cutting structure of a wire stripper.

### Related Art

For general telecommunication repairs or electrical work, usually, a wire stripper is one of necessary hand tools. A wire stripper is used to remove an outer insulative layer of a coaxial cable, a flat cable, or a wire to expose the conductor therein for electric connection.

A blade set of a wire stripper is fixed on the handles by riveting. After long-term use, the blade set for cutting will be unable to make a cut or lead to an incomplete cut to cause a poor incision which needs re-cutting. This will affect the work efficiency. In addition, the blade set is easy to be deflected when being used to implement cutting. This causes inconvenience in use.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

An object of the disclosure is to provide a wire stripper with a cutting support structure, which has support blocker plates respectively disposed on two sides opposite to each other on the blade set to prevent the blade set from dislocating to be advantageous to cutting.

Another object of the disclosure is to provide a wire stripper with a cutting support structure, whose blade set is fixed on the first handle or the second handle by multiple screws so as to be able to implement replacement when the blade set wears down.

To accomplish the above objects, the disclosure provides a wire stripper with a cutting support structure, which has a first handle, a second handle, a blade set, a spring, and a pair of support blocker plates. The second handle is pivoted to the first handle by a pivot. The blade set has a first blade and a second blade connected to the first handle and the second handle respectively. The first blade or the second blade is fixed to the first handle or the second handle by a screw, respectively. Two ends of the spring are fixed on the first handle and the second handle respectively. The support blocker plates have a first support blocker plate and a second support blocker plate, which are respectively connected on two sides opposite to each other on the first handle and the second handle respectively. An end of each of the support blocker plates is connected to the first handle, and another end thereof is extended to the second handle.

Another object of the disclosure is to provide a wire stripper with a cutting support structure, which has a pressing structure having multiple concave surfaces and protrusions adjacent to each other respectively disposed on two sides opposite to each other respectively on the first handle and the second handle to be advantageous to implement various pressing operations to increase convenience in use.

In comparison with related art, the wire stripper of the disclosure disposes the first support blocker plate and the second support blocker plate on two opposite sides of the blade set, and an end of the support blocker plate is connected to the first handle and the other end thereof extends to the second handle, so as to provide support when the blade set is implementing cutting to prevent the blade set from dislocating to be advantageous to implementing cutting. In addition, the first blade and the second blade of the disclosure are fixed to the first handle and the second handle by multiple screws, so that when the blade set wears down, the screws can be removed to implement replacement to increase convenience and utility in use.

### BRIEF DESCRIPTION OF THE DRAWINGS

FIGS. 1 and 2 are two exploded views of the support blocker plate and the blade set of the disclosure in two lateral directions;

FIGS. 3 and 4 are two assembled views of the wire stripper of the disclosure in two lateral directions;

FIG. 5 is a front view of the wire stripper of the disclosure when not in use;

FIG. 6 is a schematic plan view of the wire stripper of the disclosure in use;

FIG. 7 is a cross-sectional view of the wire stripper of the disclosure at the position of the support blocker plate; and

FIG. 8 is an exploded view showing another arrangement of the support blocker plate of the wire stripper of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

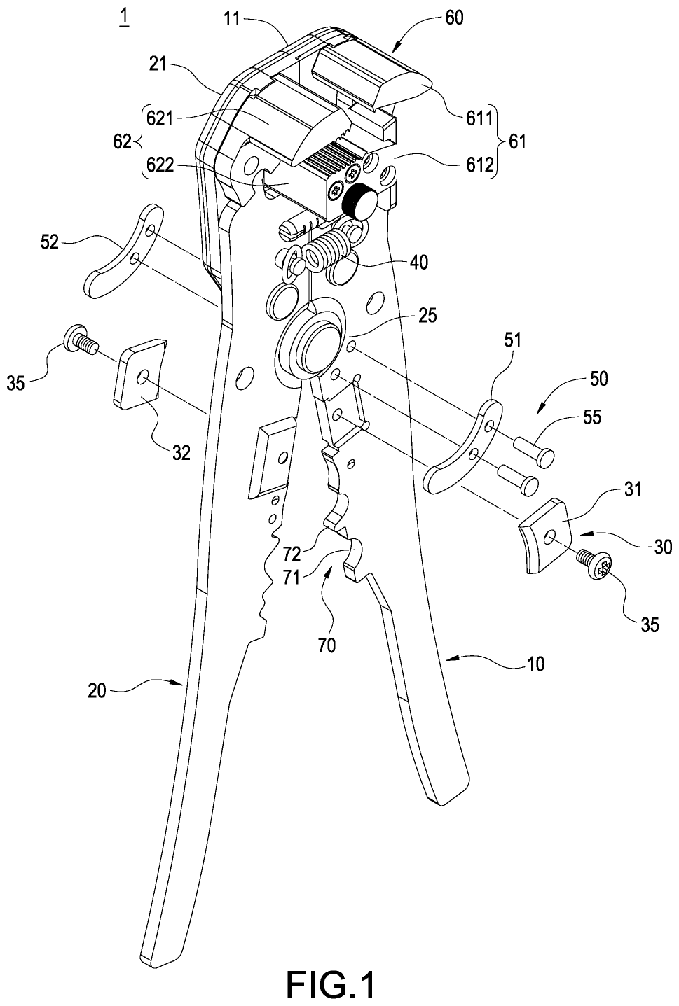

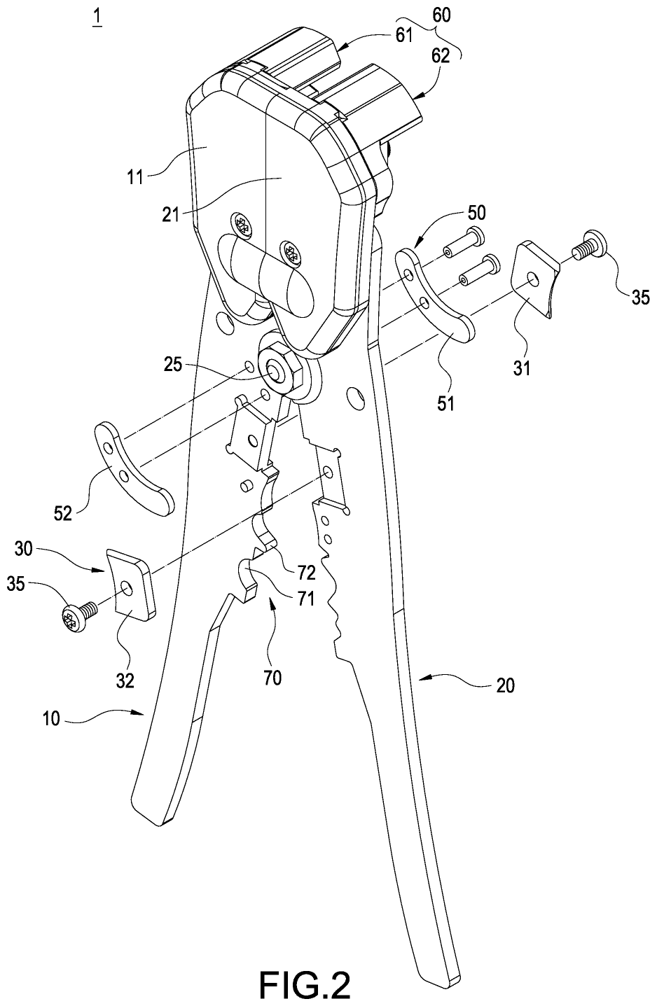

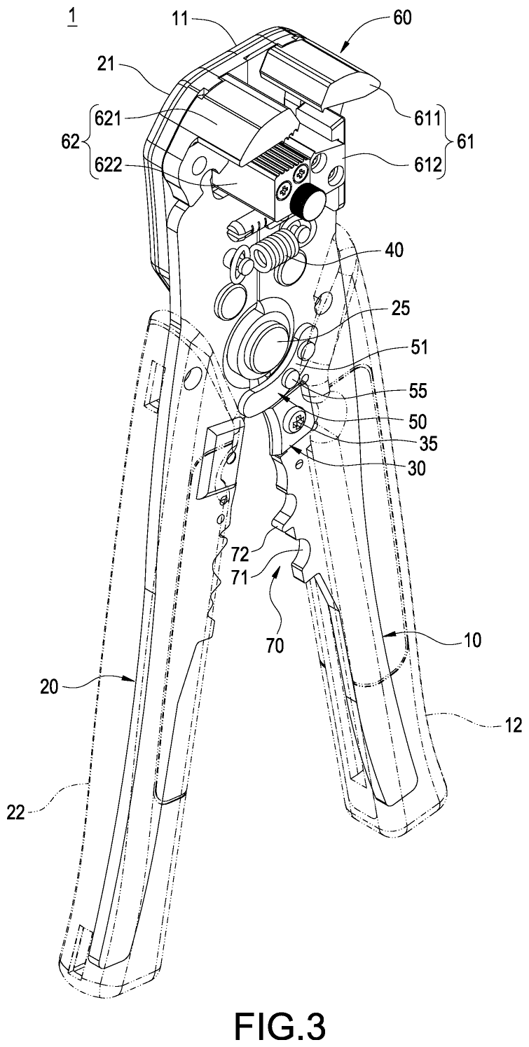

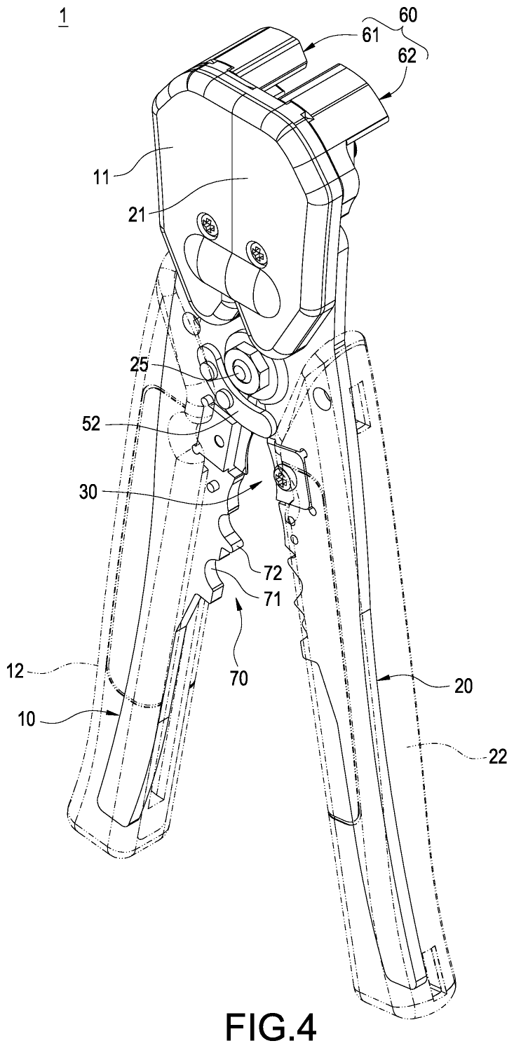

Please refer to FIGS. 1-4, which are two exploded views of the support blocker plate and the blade set of the disclosure in two lateral directions and two assembled views of the wire stripper 1 of the disclosure in two lateral directions. The disclosure provides a wire stripper 1 with a cutting support structure, which has a first handle 10, a second handle 20, a blade set 30, a spring 40 and a pair of support blocker plates 50. The first handle 10 is pivoted to the second handle 20. The blade set 30, the spring 40 and the pair of support blocker plates 50 are disposed between the first handle 10 and the second handle 20.

The second handle 20 is pivoted to the first handle 10 by a pivot 25. The first handle 10 has a first seat 11. The second handle 20 has a second seat 21 corresponding to the first seat 11.

The blade set 30 has a first blade 31 and a second blade 32, which are respectively connected to two sides opposite to each other which are respectively on the first handle 10 and the second handle 20. The first blade 31 and the second blade 32 are fixed to the first handle 10 and the second handle 20 by multiple screws 35. In detail, the blade set 30 is fixed at a position of the first handle 10 and the second handle 20, which is adjacent to the pivot 25. When the first blade 31 or the second blade 32 wears down, the screws 35 can be removed to implement replacement.

In practice, the arrangement of the blade set 30 may be only disposed with a first blade 31 on the first handle 10 and disposed with a cutting board on the second handle 20. Alternatively, the arrangement of the blade set 30 may be only disposed with a second blade 32 on the second handle 20 and disposed with a cutting board on the first handle 10.

Two ends of the spring 40 are respectively fixed on the first handle 10 and the second handle 20. The first handle 10 and the second handle 20 can be automatically opened by the returning force of the spring 40 after the two handles 10, 20 are closed to compress the spring 40.

In addition, the pair of support blocker plates 50 is disposed between the pivot 25 and the blade set 30. The pair of support blocker plates 50 is composed of two arcuate plates, preferably, two metal plates. The pair of support blocker plates 50 has a first support blocker plate 51 and a second blocker plate 52, which are respectively connected to the two sides opposite to each other which are respectively on the first handle 10 and the second handle 20. Besides, the pair of support blocker plates 50 are respectively disposed on a side of the blade set 30.

In the embodiment, an end of each of the first support blocker plate 51 and the second support blocker plate 52 is connected to the first handle 10 by multiple rivets 55, and another end thereof is extended to the second handle 20. The pair of support blocker plates 50 can provide support to both the first handle 10 and the second handle 20 while the blade set 30 is performing cutting.

In detail, the pair of support blocker plates 50 used to provide support to both the first handle 10 and the second handle 20 while the blade set 30 is performing cutting to prevent the first handle 10 and the second handle 20 from dislocating because of being pushed or pressed by an external force.

In an embodiment of the disclosure, the wire stripper 1 further has a stripping structure 60 disposed on an end of each of the first seat 11 and the second seat 21. The stripping structure 60 has a knife seat set 61 disposed on the first seat 11 and a clamp seat set 62 disposed on the second seat 21. The knife seat set 61 provides cutting and has a movable knife seat 611 and a fixed knife seat 612. Also, the clamp seat set 62 provides clamping and has a movable clamp seat 621 and a fixed clamp seat 622. The wire stripper 1 can smoothly strip the insulation off from a cable by the cooperation of the knife seat set 61 and the clamp seat set 62.

In an embodiment of the disclosure, the first handle 10 further has a first sleeve 12 and the second handle 20 further has a second sleeve 22. The first sleeve 12 and the second sleeve 22 are sleeved on the first handle 10 and the second handle 20, respectively. The first sleeve 12 and the second sleeve 22 can provide better gripping.

The wire stripper 1 further has a pressing structure respectively disposed on the two sides opposite to each other which are respectively on the first handle 10 and the second handle 20. In detail, the pressing structure 70 has multiple concave surfaces 71 and multiple protrusions 72, which are adjacent to each other. The multiple concave surfaces 71 and the multiple protrusions 72 can be used for various pressing operations to increase convenience in use.

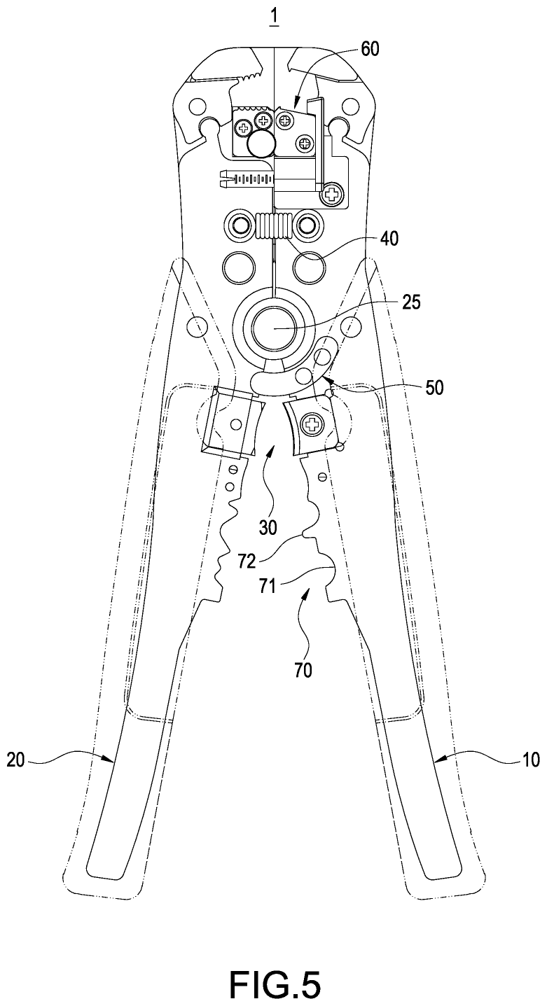

Please refer to FIGS. 5-7, which are a front view of the wire stripper of the disclosure when not in use, a schematic plan view of the wire stripper in use and a cross-sectional view of the wire stripper at the position of the support blocker plate. As shown in FIG. 5, when a user does not exert a force on the first handle 10 and the second handle 20, the spring 40 is not subjected to an external force to be in a compressed state. At this time, an open status appears between the first handle 10 and the second handle 20. In addition, an open status also appears between the blade set 30 so as to allow a wire (not shown) to be placed between the blade set 30 to be cut.

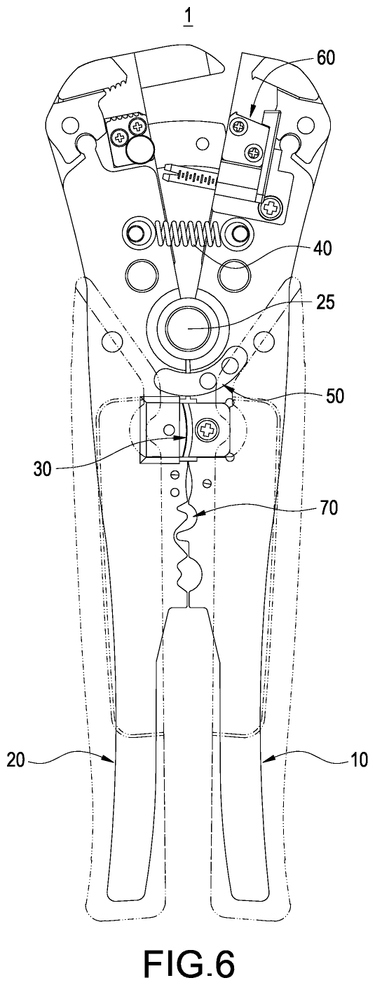

As shown in FIG. 6, when a user exerts a force on the first handle 10 and the second handle 20, the spring 40 is subjected to an external force to be in a stretched state. At this time, a closed status appears between the first handle 10 and the second handle 20. In addition, a closed status also appears between the blade set 30 so as to allow a wire (not shown) to be placed between the blade set 30 for cutting.

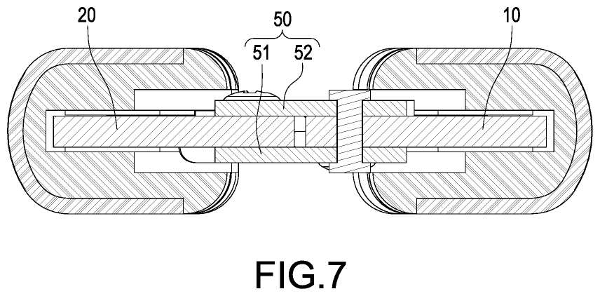

As shown in FIG. 7, the length of the pair of support blocker plates 50 extending to the second handle 20 when the blade set 30 is closed is greater than the length when the blade set 30 is opened. That is, the pair of support blocker plates 50 will provide more support to the second handle 20 when the blade set 30 is closed (implementing cutting) to prevent the first handle 10 and the second handle 20 from dislocating because of being pulled or pressed by an external force. This can prevent the blade set 30 from dislocating to cause malfunction.

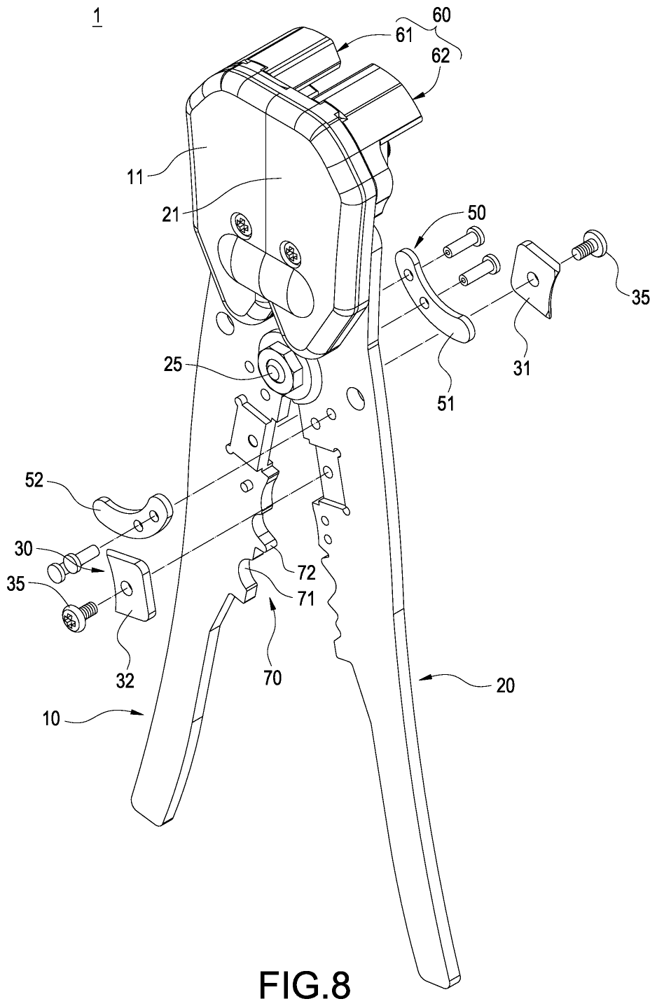

Please refer to FIG. 8, which is an exploded view showing another arrangement of the support blocker plate of the wire stripper of the disclosure. The present embodiment differs from the above embodiment by the arrangement of the support blocker plate 50. In this embodiment, the pair of support plates 50 has a first support blocker plate 51 connected on the first handle 10 and a second blocker plate 52 connected on the second handle 20.

In the embodiment, an end of the first support blocker plate 51 is connected to the first handle 10 by multiple rivets 55 and the other end thereof extends to the second handle 20. In addition, an end of the second support blocker plate 52 is connected to the second handle 20 by multiple rivets 55 and the other end thereof extends to the first handle 10. Thereby, the first support blocker plate 51 and the second blocker plate 52 are connected on two opposite sides opposite to each other which are respectively on the first handle 10 and the second handle 20 to provide support for balance.

While this disclosure has been described by means of specific embodiments, numerous modifications and variations could be made thereto by those skilled in the art without departing from the scope and spirit of this disclosure set forth in the claims.

What is claimed is:

1. A wire stripper with a cutting support structure, comprising:
a first handle;
a second handle, pivoted to the first handle by a pivot;
a blade set, comprising a first blade and a second blade connected to the first handle and the second handle respectively, and each of the first blade and the second blade fixed to the first handle or the second handle by a screw;
a spring, comprising two ends respectively fixed on the first handle and the second handle; and
a pair of support blocker plates, comprising a first support blocker plate and a second support blocker plate respectively connected on two sides opposite to each other on the first handle and the second handle respectively, each of the first support blocker plate and the second support blocker plate comprising one end connected to the first handle and another end extended to the second handle.

2. The wire stripper of claim 1, wherein the first handle comprises a first seat, and the second handle comprises a second seat corresponding to the first seat.

3. The wire stripper of claim 2, further comprising a stripping structure, and each of the first seat and the second seat comprising one end connected with the stripping structure.

4. The wire stripper of claim 3, wherein the stripping structure comprises a knife seat set disposed on the first seat and a clamp seat set disposed on the second seat, the knife seat set comprises a movable knife seat and a fixed knife seat, and the clamp seat set comprises a movable clamp seat and a fixed clamp seat.

5. The wire stripper of claim 1, wherein the pair of support blocker plates is disposed between the pivot and the blade set.

6. The wire stripper of claim 5, wherein the pair of support blocker plates are respectively fixed to the first handle and extended to the second handle.

7. The wire stripper of claim 1, further comprising a pressing structure disposed on the two sides opposite to each other on the first handle and the second handle respectively.

8. The wire stripper of claim 7, wherein the pressing structure comprises a plurality of concave surfaces and a plurality of protrusions adjacent to each other.

9. The wire stripper of claim 1, wherein one of the ends of the first support blocker plate is connected to the first handle and another of the ends of the first support blocker plate is extended to the second handle, and one of the ends of the second support blocker plate is connected to the second handle and another of the ends of the first support blocker plate is extended to the first handle.
